(19) United States
(12) Patent Application Publication
(10) Pub. No.: US 2012/0084983 A1
(43) Pub. Date: Apr. 12, 2012

(54) DRIVE SYSTEM FOR ROTARY DRIVEN HAIR CLIPPERS

(75) Inventor: Russell L. Moseman, Sterling, IL (US)

(73) Assignee: WAHL CLIPPER CORPORATION, Sterling, IL (US)

(21) Appl. No.: 12/901,045

(22) Filed: Oct. 8, 2010

(51) Int. Cl. B26B 19/02; B26B 19/28

(52) U.S. Cl. 30/43.92; 30/42

(57) ABSTRACT

A hair cutting device has a stationary blade, a reciprocating blade and a rotary motor. The reciprocating blade has a cam follower in contact with the top surface of the reciprocating blade, and a slot for receiving a cam. The cam is secured to the motor shaft on one end, and has an offset pin on the other end. The offset pin fits in the cam follower slot so that when the motor rotates the cam through rotational cycles, the offset pin oscillates the reciprocating blade back and forth. The offset pin extends at least to or through the plane of the reciprocating blade for the entire rotational cycle of the offset pin, which reduces torque and twisting of the reciprocating blade.

This invention relates to rotary driven hair clippers, hair trimmers and the like, and more particularly to cam drive systems for rotary driven hair cutting devices.

### BACKGROUND OF THE INVENTION

Electric hair clippers generally have a stationary blade having a row of teeth along one edge, and a reciprocating blade having a complimentary row of teeth. The reciprocating blade is driven by a motor so that hair that enters between the teeth of the stationary blade is cut by the oscillating action of the reciprocating blade.

Some hair clippers are driven by a vibrator motor. Since the vibrator motor itself creates a back-and-forth motion, the motor can essentially directly drive the reciprocating blade, as in Wahl U.S. Pat. No. 1,774,046.

Other hair clippers, beard trimmers and the like also have a stationary blade and reciprocating blade, but the reciprocating blade is driven by a rotary motor. An example of a conventional rotary driven hair clipper is shown in FIG. 9. A reciprocating blade 900 is driven back and forth by a rotary motor 902 having a rotary shaft 904. The rotation of the motor shaft 904 is converted to an oscillating motion using a cam 906. The cam 906 has an offset pin 908. Rotary motion of the pin 908 is converted to oscillating motion in the reciprocating blade 900 through a cam follower 910. The cam follower 910 is usually located between the cam 906 and the reciprocating blade 900. However, the offset pin 908 and the reciprocating blade 900 are separated from each other, so the pin imposes a torque or twisting action on the reciprocating blade. This can cause fishtailing or change in the tension applied to the blade, which degrades cutting performance, increases noise and increases wear.

Accordingly, one object of the present invention is to provide rotary driven hair clippers, hair trimmers and the like that have improved cutting performance, reduced noise and reduced wear.

### SUMMARY OF THE INVENTION

In keeping with one aspect of this invention, a hair cutting device has a stationary blade having a row of stationary teeth along one edge, and can have a track located below and parallel to the row of stationary teeth. A reciprocating blade has a row of reciprocating teeth, a top surface forming a plane, and a bottom surface. A track guide is provided on the bottom surface if the stationary blade has a track. The stationary teeth and reciprocating teeth compliment each other and cut hair inserted in the teeth when the reciprocating blade moves back and forth in the track.

The reciprocating blade also has an opening in the top surface for insertion of a cam follower. The cam follower has a surface in contact with the top surface of the reciprocating blade, and a slot opening for receiving a cam. The cam is secured to the shaft of a rotary motor.

The cam has an offset pin configured to fit in the cam follower slot so that when the motor rotates the cam through rotational cycles, the offset pin oscillates the reciprocating blade back and forth. The offset pin extends at least to or through the plane of the reciprocating blade for substantially the entire rotational cycle of the offset pin.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a cutaway perspective view of a hair clipper incorporating one embodiment of the present invention;

FIG. 2 is a front cutaway view of the hair clipper of FIG. 1;

FIG. 3a is a side view of part of the hair clipper of FIG. 1, with the cam at the top position of its rotational cycle;

FIG. 3b is a cross-sectional side view of part of the hair clipper of FIG. 1, with the cam at the bottom position of its rotational cycle;

FIG. 4 is a cutaway front view of the hair clipper of FIG. 1;

FIG. 5 is a perspective view of the CAM used in the hair clipper of FIG. 1;

FIG. 6 is a top view of the CAM follower and blade set in the hair clipper of FIG. 1;

FIG. 7 is a perspective top view of the CAM follower in the hair clipper of FIG. 1;

FIG. 8 is a perspective bottom view of the CAM follower used in the hair clipper of FIG. 1; and

FIG. 9 is a cutaway perspective view of a conventional hair clipper in the prior art.

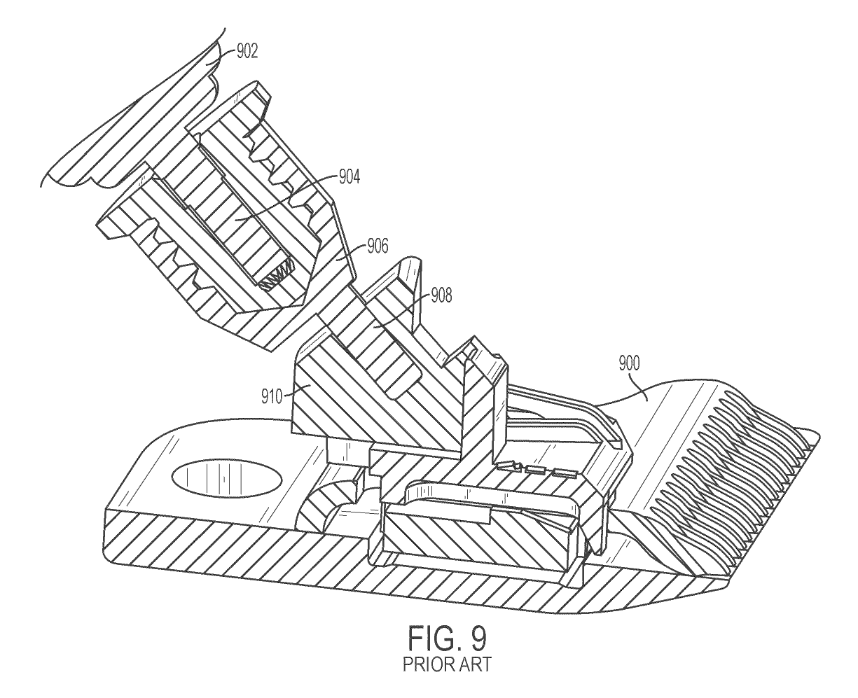

### DETAILED DESCRIPTION

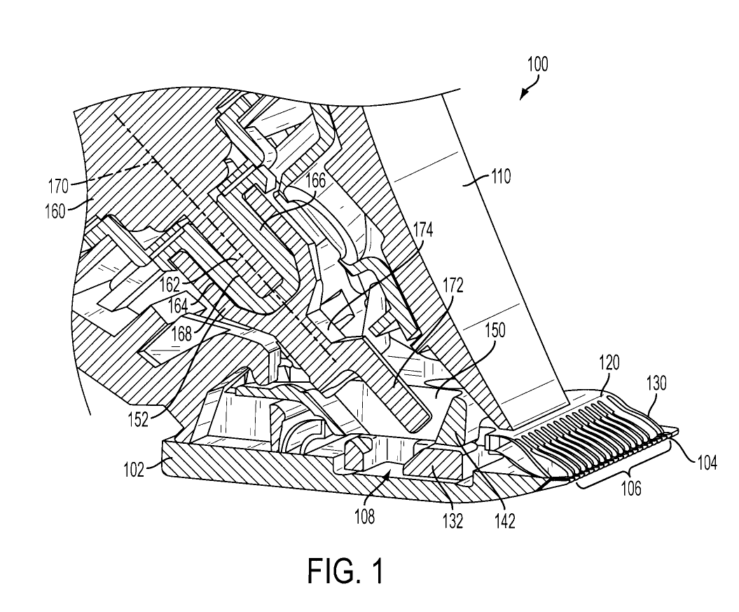

As seen in FIGS. 1-3b, a hair clipper 100 includes a stationary blade 102 having a row of stationary teeth 104 along an edge 106. Stationary blade 102 can be secured to a housing 110 by screws (not shown). A track 108 is spaced from and parallel to the edge 106. The track 108 is typically a depression milled, ground or rolled into the blade.

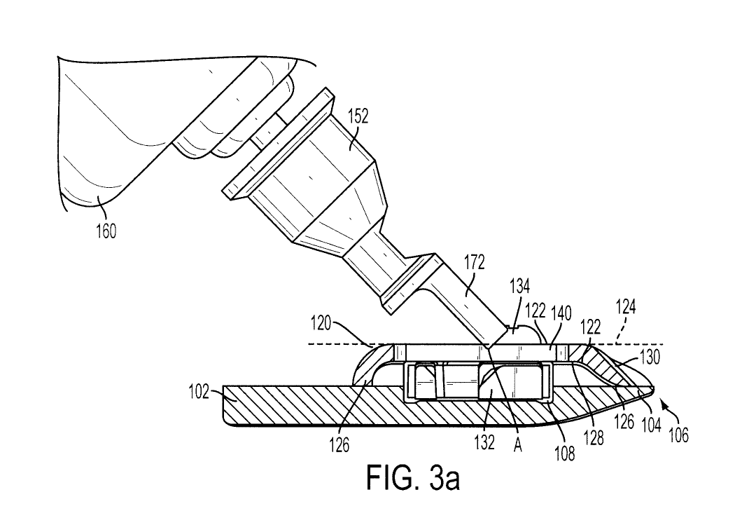

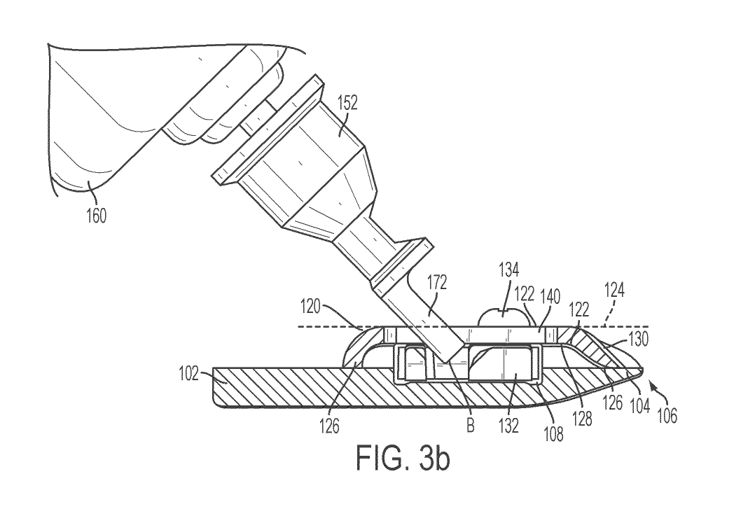

A reciprocating blade 120 has a top surface 122 that forms a plane 124 (FIGS. 3a-3b), stationary blade engaging surfaces 126, and an elevated bottom surface 128. A row of reciprocating teeth 130 is provided close to and along the edge 106.

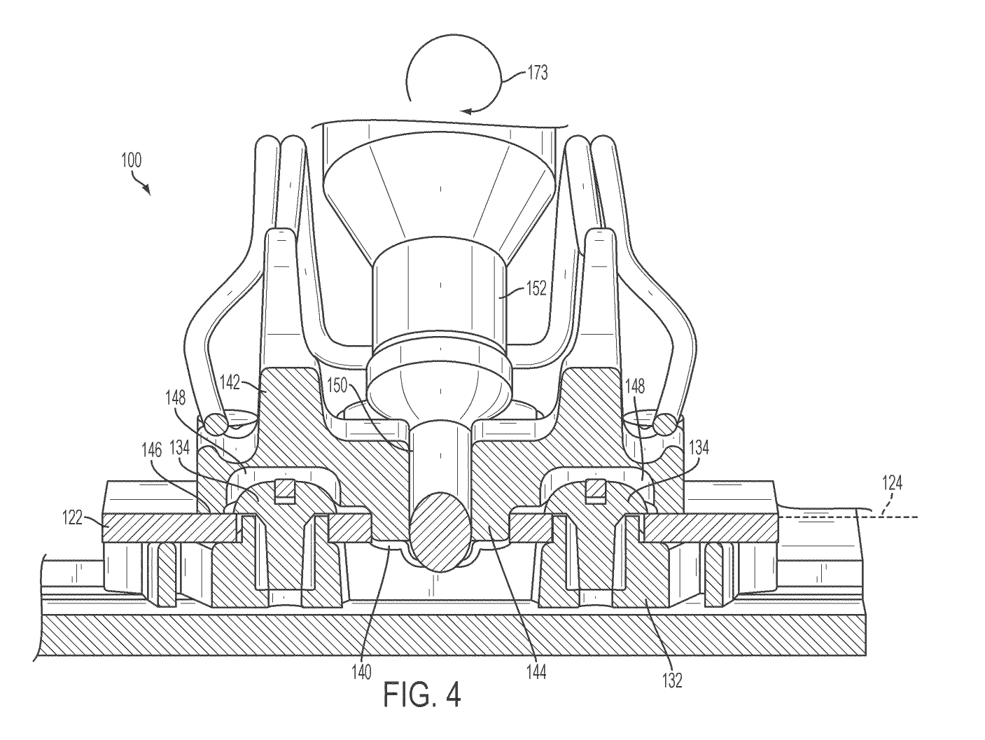

A track guide 132 is secured to the elevated bottom surface 128 by a pair of screws 134 (FIG. 4). The track guide 132 (FIGS. 3a-3b) fits in the track 108 of the stationary blade 102 so that the stationary teeth 104 and the reciprocating teeth 130 compliment each other and cut hair inserted in the teeth when the reciprocating blade 120 moves back and forth.

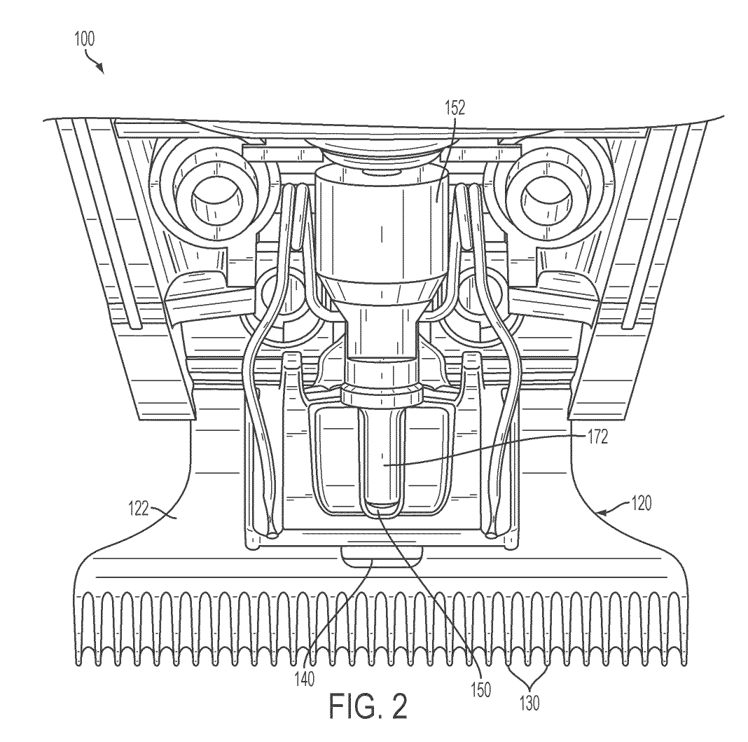

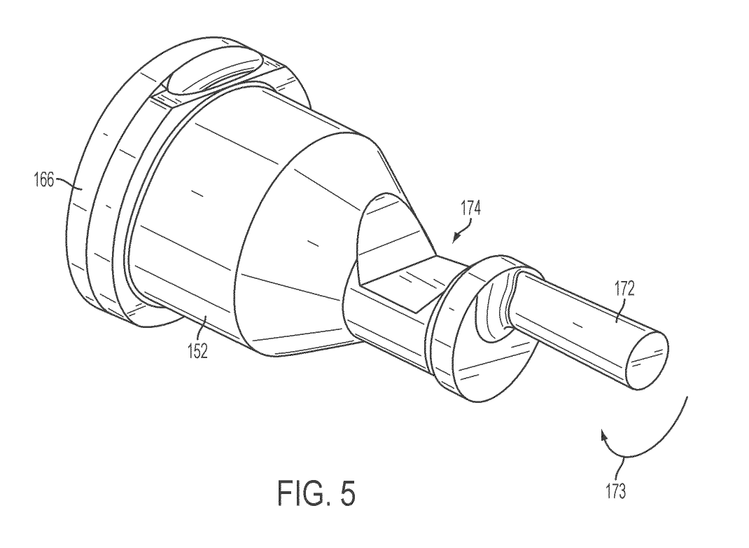

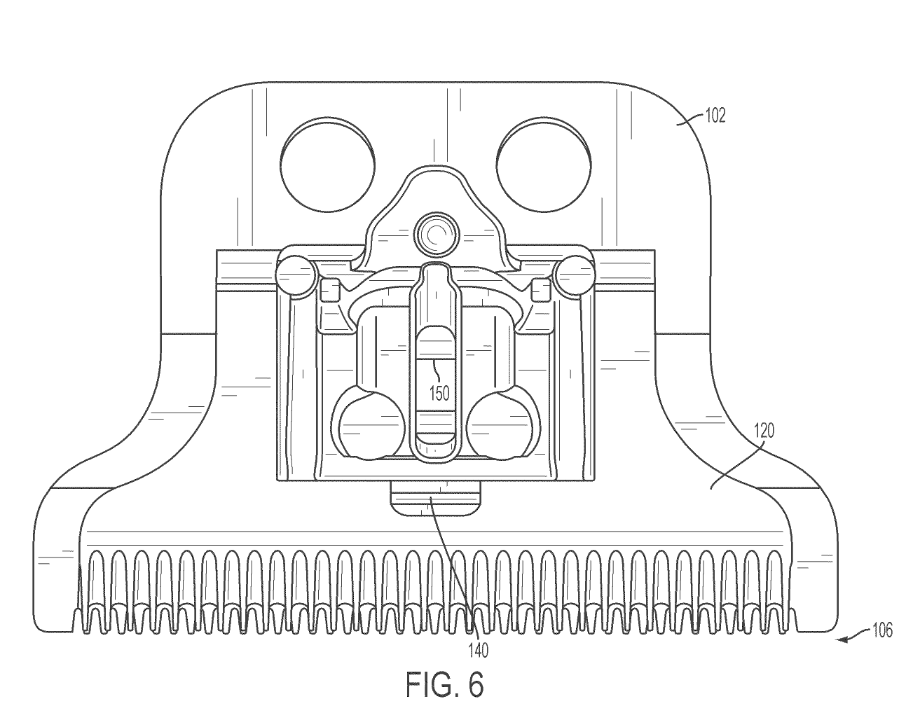

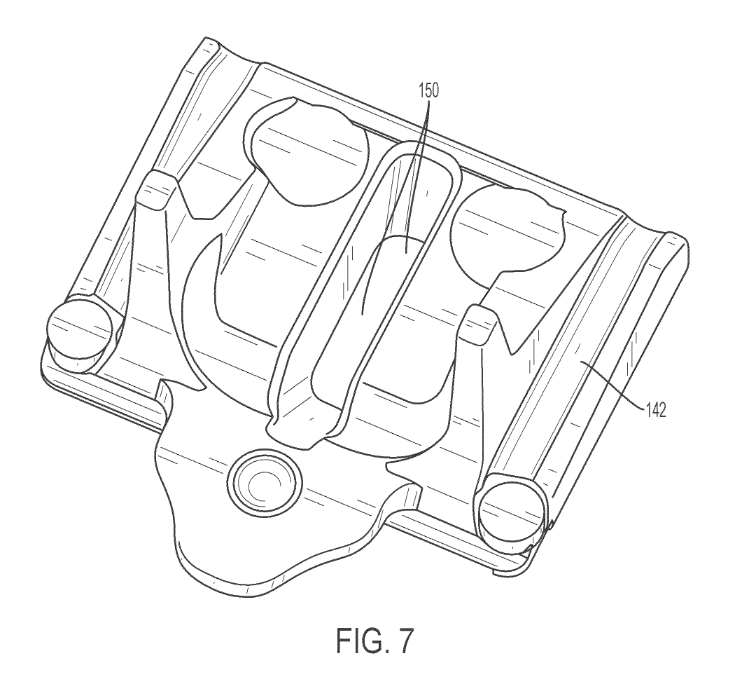

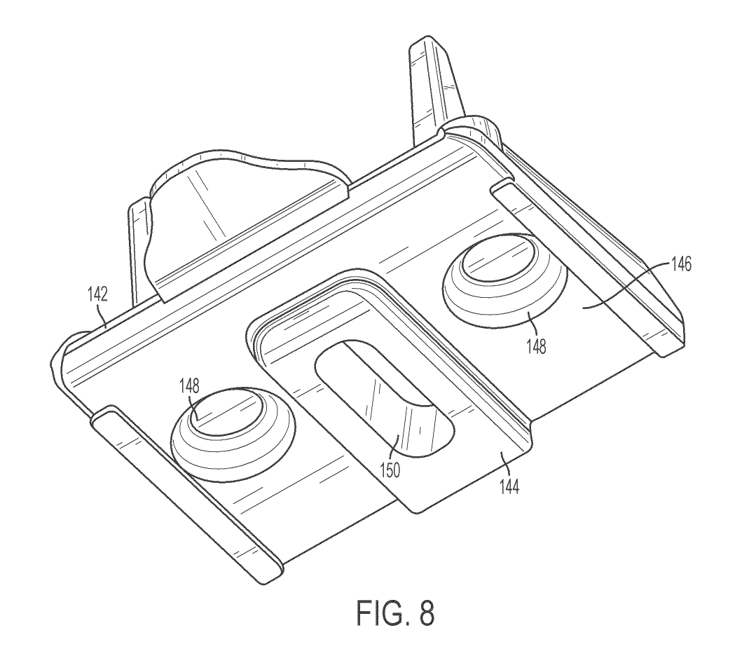

The reciprocating blade 120 has a blade opening 140 (FIGS. 2 and 4) in the top surface 122. A cam follower 142 has a protrusion 144 (FIG. 8) in the blade opening 140. A surface 146 of the cam follower 142 is in contact with the top surface 122 of the reciprocating blade 120 (FIG. 4). A pair of depressions 148 fit over the heads of the screws 134, to better align and engage the cam follower 142 on the reciprocating blade 120. The cam follower 142 has an elongated slot 150 (FIGS. 6-8) for receiving an offset cam pin 172 (FIG. 5).

A rotary motor 160 (FIG. 1) is also provided in the housing 110, with a battery (not shown) and related components. The motor 160 has a shaft 162 that rotates in operation.

The cam 152 (FIG. 1) includes an opening 164 in which a plastic insert 166 is located. The plastic insert 166 has an insert opening 168 into which the motor shaft 162 fits so that the cam and the shaft are centered and rotate around a motor axis 170.

The cam 152 (FIG. 5) has the offset cam pin 172 on the end opposite the opening 164. The cam is balanced by removing material to form a groove 174, to reduce wear on the motor.

The offset cam pin 172 is located in the elongated slot 150 of the cam follower 142. The pin 172 has a rotational cycle in a direction 173 that takes its lowermost point between a top position A in FIG. 3a and a bottom position B in FIG. 3b. In the drawings, both positions A and B are below the plane 124. The cam follower 142 is not shown in FIGS. 3a and 3b.

When the motor 160 rotates the cam 152 through rotational cycles, the offset cam pin 172 oscillates the reciprocating blade 120 back and forth. The offset cam pin 172 extends at least to or through the plane 124 on the reciprocating blade 120 for the entire rotational cycle of the offset cam pin 172. In this manner, the cam remains within the plane of the reciprocating blade at all times, which eliminates torsional twisting and rocking when the reciprocating blade oscillates. The cam is closer to the reciprocating teeth, which reduces fishtailing of the blades of the reciprocating blade as it moves back and forth.

While the principles of the invention have been described above in connection with specific apparatus and applications, it is to be understood that this description is made only by way of example and not as a limitation on the scope of the invention.

What is claimed is:

1. A hair cutting device comprising:
a stationary blade having a row of stationary teeth along one edge,
a reciprocating blade having a top surface forming a plane, a bottom surface, and a row of reciprocating teeth that compliment the stationary teeth and reciprocate so as to cut hair inserted in the stationary teeth when the reciprocating blade moves back and forth,
the reciprocating blade also having an opening in the top surface for insertion of a cam follower, the cam follower having a surface in contact with the top surface of the reciprocating blade and a slot for receiving a cam,
a rotary motor having a shaft, and
a cam secured to the motor shaft, the cam having an offset pin configured to fit in the cam follower slot so that when the motor rotates the cam through rotational cycles, the offset pin oscillates the reciprocating blade back and forth,
wherein the offset pin extends at least to or through the plane of the reciprocating blade for the entire rotational cycle of the offset pin.

2. The hair cutting device of claim 1, wherein the stationary blade includes a track located below and parallel to the row of stationary teeth, and
the reciprocating blade includes a track guide on a bottom surface that fits in the track of the stationary blade.

3. The hair cutting device of claim 2, wherein the track is a depression milled into the stationary blade.

4. The hair cutting device of claim 2, wherein the track is a depression ground into the stationary blade.

5. The hair cutting device of claim 2, wherein the track is a depression rolled into the stationary blade.

6. The hair cutting device of claim 2, wherein the track is spaced from and parallel to an edge formed by the row of stationary teeth.

7. The hair cutting device of claim 2, wherein the track guide is secured to the bottom surface of the reciprocating blade by screws.

8. The hair cutting device of claim 1, wherein the cam includes an opening in which a plastic insert is located, the plastic insert having an opening into which the motor shaft fits so that the cam and the shaft are centered and rotate around a motor axis.

9. The hair cutting device of claim 1, wherein the cam is balanced by removing material to form a groove.
